(19) United States
(12) Patent Application Publication
(10) Pub. No.: US 2007/0150585 A1
(43) Pub. Date: Jun. 28, 2007

(54) Multi-dimensional aggregation on event streams

(75) Inventor: Gueorgui B. Chkodrov, Redmond, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/320,349

(22) Filed: Dec. 28, 2005

(51) Int. Cl. G06F 15/173

(52) U.S. Cl. 709/224

(57) ABSTRACT

Multi-dimensional aggregation on event streams for generating reports based on metadata about what events are available. An aggregation definition tool receives the event stream and, responsive to user input, identifies events of interest and specifies a correlation pattern for defining activities from the events. A user interface permits a user to define a desired dimensional structure of the reports and a mapping between data items in the events and the dimensional structure.

### BACKGROUND

Many business enterprises use computer systems to monitor and process business activities and transactions. Business entities that handle complex transactions and activities, in particular, often employ distributed computer systems. As such, current networks, systems, applications, and businesses are inherently distributed and event-driven.

For example, an online retailer may use a business application to receive online purchase orders, an inventory application to manage the store's inventory and to communicate with its suppliers, and other applications or services to create online interfaces and to manage shipping. In another example, a web server often faces heavy client loads and serves many scripts registered on a number of different uniform resource locators (URLs). Because each client request can cause multiple monitoring events, and the requests are handled asynchronously and independently of each other, the server generates a continuous stream of monitoring events. In this example, a network administrator may be very interested in analyzing the network's performance based on these monitoring events.

Events of interest happen in various places throughout an enterprise. Unfortunately, the users of such event-driven systems are frequently unable to easily extract information from the event streams because there is no central place to easily evaluate the information contained in the events or to examine holistic patterns of interest. This results in blindness to valuable information in an event-driven enterprise, which can seriously impair a user's ability to identify and react to changing and developing situations.

Multiple technologies currently exist for monitoring and centralizing remote events. For example, operations management tools provide monitoring and alerting as well as reporting and trend analysis for managing server events. And audit collection services manage security events. In the retail world, the conventional radio frequency identification (RFID) framework has become very popular for tracking inventory and the like. But users are still unable to quickly, easily, and intuitively define reports for aggregating event information.

For example, current business activity monitoring (BAM) user experience emphasizes the business process and separates the roles of the business analyst and developer. In the canonical BAM solution, first a business analyst defines an observation model (i.e., desired data views) and then a developer maps this model to the available events in the implementation. Even though this top-down approach works well for BAM, it does not provide an intuitive solution when the system is configured by a single user who understands the available events and wants to go essentially from the bottom up, that is, from events to reports.

### SUMMARY

Embodiments of the invention overcome one or more deficiencies in known reporting systems by providing improved event reporting in which a user can directly define reports based on metadata about what events are available. As such, aspects of the invention allow users to think how they want to “shape up” event streams into data and multi-dimensional aggregations, without any knowledge of SQL and Data Warehousing. By centralizing events of interest, users can easily generate data views of event streams and use correlation processors such as those available in BAM tools. In one aspect, the invention captures user input specifying events that are of interest, a desired correlation pattern, and a desired dimensional structure and then maps between data items in the events and the dimensional structure. Advantageously, aspects of the invention operate in conjunction with current BAM runtime to manipulate virtually any kind of event stream into aggregations.

Computer-readable media having computer-executable instructions for generating reports from event streams and defining an intuitive user experience embody further aspects of the invention. Alternatively, embodiments of the invention may comprise various other methods and apparatuses.

Other features will be in part apparent and in part pointed out hereinafter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating components of an exemplary computer system implementing an embodiment of the invention.

FIG. 2 is a block flow diagram illustrating an exemplary event stream source for use with an embodiment of the invention.

FIG. 3 is an exemplary screen shot illustrating aspects of a multi-dimensional aggregation according to an embodiment of the invention.

FIG. 4 is an exemplary screen shot illustrating further aspects of a multi-dimensional aggregation according to an embodiment of the invention.

FIG. 5 is an exemplary screen shot illustrating aspects of a user interface for selecting events of interest according to an embodiment of the invention.

FIG. 6 is an exemplary screen shot illustrating aspects of a user interface for defining activity semantics according to an embodiment of the invention.

FIG. 7 is an exemplary screen shot illustrating aspects of a user interface for defining a dimensional structure and mapping from event schema according to an embodiment of the invention.

FIG. 8 is a block diagram of an exemplary computer system implementing further aspects of an embodiment of the invention.

FIG. 9 is a flow diagram illustrating exemplary operations for generating reports from an event stream according to an embodiment of the invention.

FIG. 10 is a block diagram illustrating an exemplary computer-readable medium containing computer-executable instructions for implementing aspects of the invention.

Corresponding reference characters indicate corresponding parts throughout the drawings.

### DETAILED DESCRIPTION

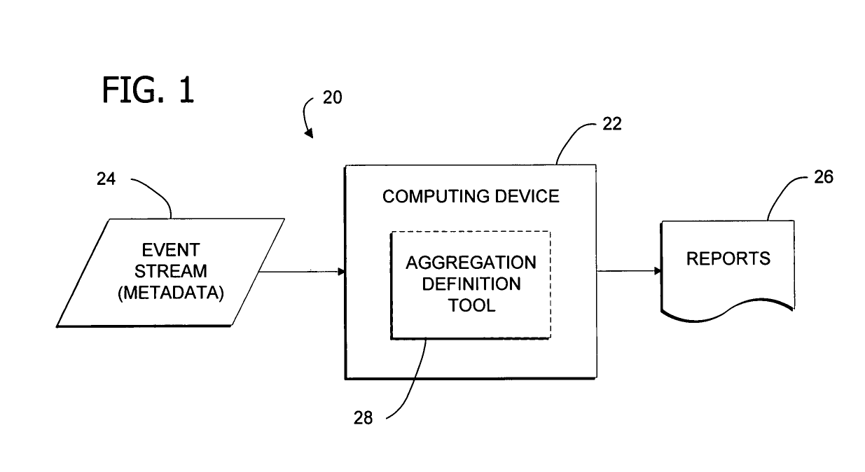

Referring now to the drawings, FIG. 1 illustrates an exemplary computing environment 20 in which the present invention may be implemented for defining multi-dimensional aggregations on event streams. As shown, a computing device 22 executes computer-executable instructions for processing an event stream 24 to generate one or more reports 26 representative of the information in the stream. In one embodiment, an aggregation definition tool 28 implemented on computing device 22 captures user input relating to which events in event stream 24 are of interest, what is the desired correlation pattern, what is the desired dimensional structure, and what is the mapping between the data items in the events and the dimensional structure.

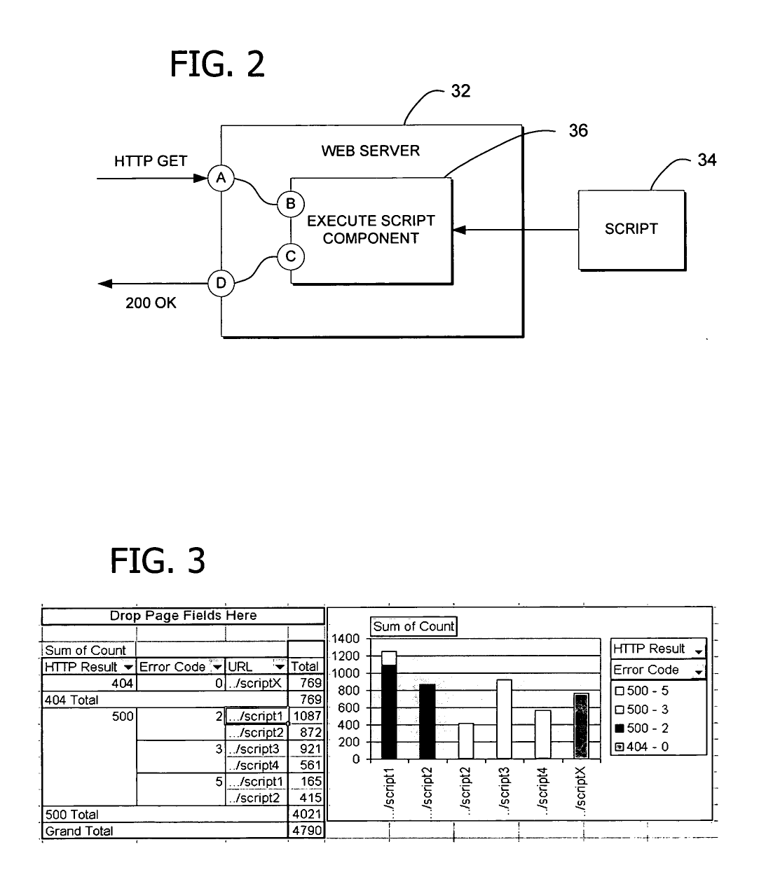

To illustrate aspects of the invention, FIG. 2 presents an example of event stream 24. In this instance, the event stream 24 comprises a stream of diagnostic events in a web server 32. An administrator or other user of the server 32 can obtain various reports by defining how the event data is “shaped up”. For purposes of illustration, web server 32 is capable of executing external scripts 34 and is instrumented with four monitoring events (shown generally at A, B, C, and D). When a client opens a socket to server 32, it may send a request (e.g., HTTP GET) with the URL of the script 34 and some arguments. The server 32 then locates and executes the appropriate script 34, which produces some output. FIG. 2 shows a component 36 for executing scripts 34. The server 32 replies back with a status code, such as 200 (OK) or 500 (Internal Server Error), and streams the output from the script or the error information to the client before closing the socket.

In one embodiment, four diagnostic events A, B, C, and D are available for monitoring web server 32. At A, an event HTTPRequest_Begin contains data such as the URL and the size of the incoming request in bytes; at B, an event ScriptExecution_Begin occurs when server 32 spawns the script process (e.g. Peri interpreter); at C, an event ScriptExecution_End indicates when the executed script 34 is completed (or a resultant error code); and at D, an event HTTPRequest_End occurs when the request is completed (including any error code). In this example, the list of events that can possibly happen and the shape of the data they will contain (i.e., their schema) is known ahead of time. According to aspects of the invention, the aggregation definition tool 28 utilizes event metadata for processing event stream 24. The event metadata for the example of FIG. 2 may be embodied by an extensible markup language (XML) file such as the one shown below in which Item Name specifies the metadata:

<Event Name=“HTTPRequest_Begin” Id=“235”>

<Item Name=“RequestID” Type=“Guid”/>
<Item Name=“FromIP” Type=“String”/>
<Item Name=“URL” Type=“String”/>
<Item Name=“BytesIn” Type=“Int32”/>

</Event>
<Event Name=“ScriptExecution_Begin” Id=“236”>

<Item Name=“RequestID” Type=“Guid”/>

</Event>
<Event Name=“ScriptExecution_End” Id=“237”>

<Item Name=“RequestID” Type=“Guid”/>
<Item Name=“ReturnCode” Type=“Int32”/>

</Event>
<Event Name=“HTTPRequest_End” Id=“238”>

<Item Name=“RequestID” Type=“Guid”/>
<Item Name=“ResultCode” Type=“Int32”/>
<Item Name=“BytesOut” Type=“Int32”/>

</Event>

Referring further to FIG. 2, server 32 may face heavy loads from many clients and serve many different scripts 34 registered on different URLs. Because each request causes four monitoring events in this example, and the requests are handled asynchronously and independently of each other, server 32 generates a continuous stream of monitoring events. Thus, the events for the requests that are being processed simultaneously will be interleaved.

It is not unlikely that at least some of the scripts 34 contain errors and will fail. When such errors occur, web server 32 returns an error 500 (Internal Server Error) to the client but may not propagate the error code for security reasons. The administrator of server 32 is likely interested to see which scripts 34 are failing, how often, and with what error codes. FIG. 3 is an exemplary screen shot illustrating aspects of a multi-dimensional aggregation according to an embodiment of the invention that provides this type of information to the administrator is a useful format (e.g., error reasons per URL). The information is contained in the stream of monitoring events (e.g., event stream 24).

In the web server example, the URL is in one event, the error code from the script 34 is in another event, and the HTTP Result Code is in yet another event. To obtain the exemplary report shown in FIG. 3, system 20, which includes aggregation definition tool 28, correlates or “puts together” the events for each individual request. In other words, aggregation definition tool 28 allows system 20 to accumulate the events of interest into a record that represents the whole activity (i.e., unit of work) and then aggregate the activities into multi-dimensional structures. In FIG. 3, the multi-dimensional aggregation accumulates the total number of calls, grouped by URL and by {HTTPResult, ReturnCode}.

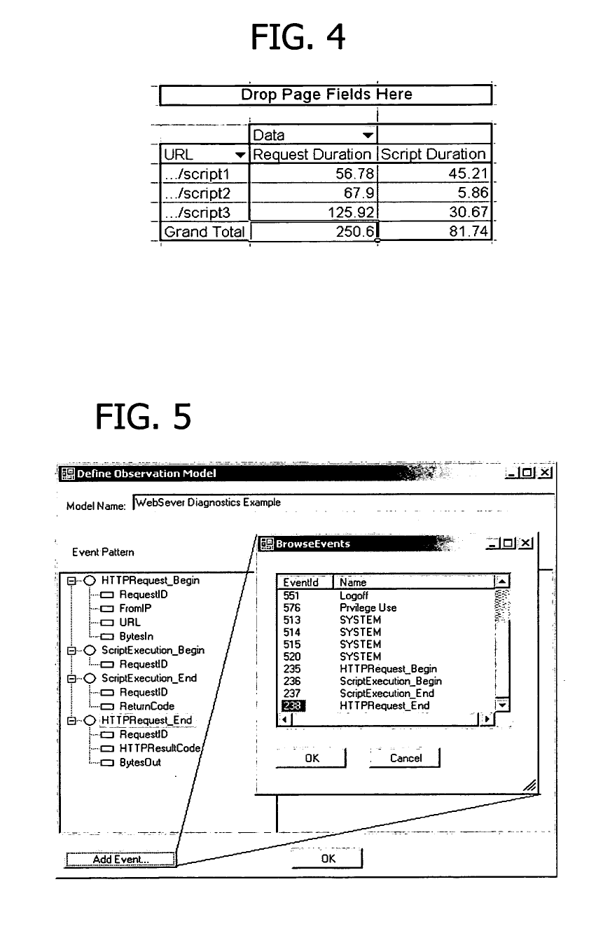

Another report of interest to the administrator of web server 32 may be about the performance of the server (e.g., how long does it take to execute the request for each URL, and what percentage of this time is spent waiting for script 34 to complete). FIG. 4 is an exemplary screen shot illustrating further aspects of a multi-dimensional aggregation according to an embodiment of the invention. In this example, system 20 presents a report showing request duration per URL (i.e., duration between events A and D) and script duration per URL (i.e., duration between events B and C). In the illustrated structure, the report has one dimension (URL) and two measures (request duration and script duration).

As with the earlier example, the data of interest is contained in multiple events. For example, the URL is in HTTPRequest_Begin; the average duration of the request is calculated by averaging the time between HTTPRequest_Begin and HTTPRequest_End for each request; and the script duration is calculated by averaging the time between ScriptExecution_Begin and ScriptExecution_End. The administrator of web server 32 again knows about the events based on their metadata. In this instance, the administrator may already know what reports are desired and have at least a high-level idea about how the data should be processed. Unfortunately, existing technologies require a developer to take this information as requirements and then build a data warehouse to generate the reports of interest. Embodiments of the present invention advantageously allow the administrator to capture the requirements in such a structured way that they are directly executable.

Referring now to FIGS. 5, 6, and 7, aspects of the invention capture user input in three steps: select events of interest, specify the correlation (i.e., Activity semantics), and specify how the event data is transformed for aggregations (i.e., dimensional structure and mapping).

FIG. 5 is an exemplary screen shot illustrating aspects of a user interface for selecting events of interest according to an embodiment of the invention. FIG. 5 continues the example of web server 32. As shown, the user interface provides a tool for defining the observation model or, in other words, selecting events of interest. The left pane of the tool shows empty at the beginning. When the administrator clicks on an “Add Event” button, the user interface displays a dialog box, for example, which shows a list of the events as per the metadata. The administrator may then select the events of interest (and click OK). The dialog box, or popup window, disappears and the left pane is now filled with the schemas of the events that were selected. In this instance, system 20 retrieves the schemas from the event metadata.

The user interface of FIG. 5 also permits the administrator to define the correlation criteria, that is, what he or she considers being an indication that multiple events belong to the same Activity (e.g., HTTP request). For example, the administrator may select the RequestID for grouping events by right-clicking on the field “RequestID” in each event and choosing “Make Correlation Key” from a context menu. In addition, the administrator specifies which of the events are the first (Begin) and the last (End) events in the defined Activity. For example, the administrator makes this selection by right-clicking on the Event Roots and choosing “Begin”/“End” from a context menu. It is to be understood that the user interface descriptions are merely exemplary and the user could specify events of interest and correlation criteria in other ways (e.g., drag and drop or check box).

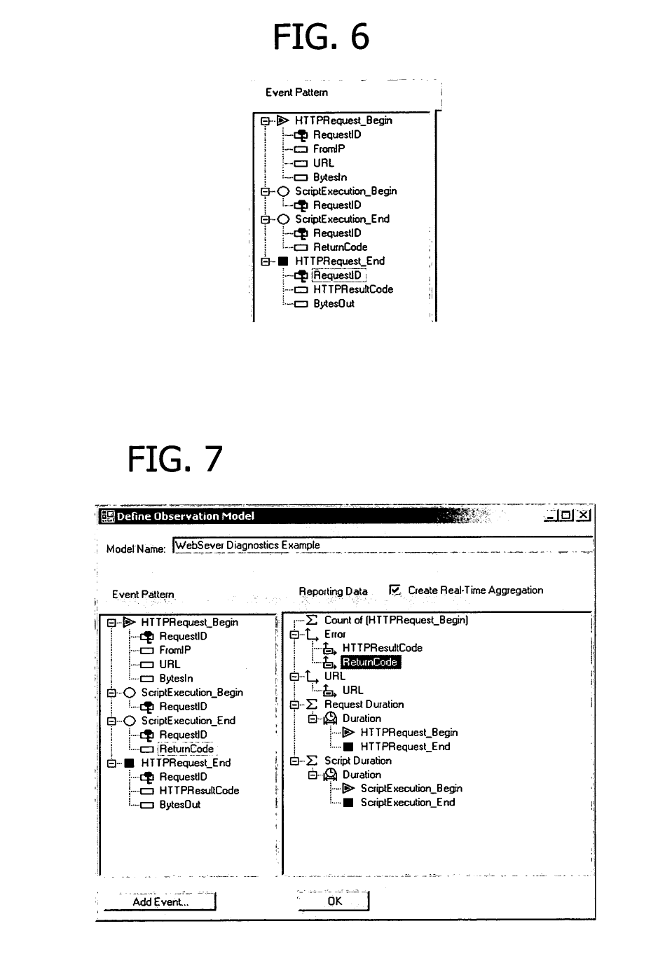

As result of these operations, the view in the left pane of FIG. 5 now appears as shown in FIG. 6. FIG. 6 is an exemplary screen shot illustrating aspects of the user interface for defining Activity semantics (e.g., Correlation, Begin and End events) according to an embodiment of the invention. In this example, the administrator right-clicks to mark RequestID as a Correlation Key (i.e., which events correlate to this RequestID). A graphical icon at the root of HTTPRequest_Begin indicates that this is the Begin event for the Activity (e.g., changing a circle at the root to a green triangle). Similarly, a graphical icon at the root of HTTPRequest_End indicates that this is the End event for the Activity (e.g., changing a circle at the root to a red square). The payload data item “RequestID” in both events is highlighted in FIG. 6 as Correlation Key.

More events may belong to the same Activity that are neither Begin nor End, and there may be multiple Begin/End events as long as only one of them happens in any specific instance of the Activity. Also, in the example of FIG. 6, a single Correlation Key is being used. Those skilled in the art will appreciate that the administrator can define more complex patterns (e.g., similar to BAM Continuation) with slightly more complex UI gestures.

Specifying the Correlation Key and Begin-End informs the stream processing system how to deem some event instances as belonging together, when to initiate a new instance, and when to get rid of the data. Alternatively, such Activity semantics may already exist in the form of annotations in the event metadata, as shown in the example below:

<Event Name=“HTTPRequest_Begin” Id=“235” ActivityBegin=“True”
CorrelationKey=“RequestID”>

<Item Name=“RequestID” Type=“Guid”/>
<Item Name=“FromIP” Type=“String”/>
<Item Name=“URL” Type=“String”/>
<Item Name=“BytesIn” Type=“Int32”/>

</Event>
<Event Name=“ScriptExecution_Begin” Id=“236” CorrelationKey=“RequestID”>

<Item Name=“RequestID” Type=“Guid”/>

</Event>
<Event Name=“ScriptExecution_End” Id=“237” CorrelationKey=“RequestID”>

<Item Name=“RequestID” Type=“Guid”/>
<Item Name=“ReturnCode” Type=“Int32”/>

</Event>
<Event Name=“HTTPRequest_End” Id=“238” ActivityEnd=“True”
CorrelationKey=“RequestID”>

<Item Name=“RequestID” Type=“Guid”/>
<Item Name=“ResultCode” Type=“Int32”/>
<Item Name=“BytesOut” Type=“Int32”/>

</Event>

In this instance, because the metadata specified the Activity semantics, the administrator can skip the previous manual step and only select the events of interest, again obtaining the result as shown in FIG. 6.

Once the administrator in this example has specified the events of interest and the Activity semantics, the administrator can define how the activities are aggregated. To do so in this example, the administrator drags items from the event schema on the left, into the right pane of the UI of FIGS. 5, 6, and 7. Once an item is dropped, it supports a Context Menu with options such as “Make Measure” or “Make Dimension”. By choosing from these options, the administrator defines a new tree structure with accompanying icons in the right pane. FIG. 7 is an exemplary screen shot illustrating aspects of the user interface for defining a dimensional structure and mapping from event schema according to an embodiment of the invention to support the desired reports (e.g., FIGS. 3 and 4).

Further to the web server example, the administrator may notice that the desired report, such as the one shown in FIG. 3, uses the count of all requests. This is the same as the count of occurrences of the event HTTPRequest_Begin. Therefore, the administrator drags the root of that event to the right, then right-clicks on it and chooses “Make Measure”. At this point, a circle icon changes to a sum symbol. The report of FIG. 3 distinguishes the counts for different URLs. In this instance, the URL is a dimension so the administrator drags “URL” to the right and chooses “Make Dimension” from its context menu.

The counts on FIG. 3 are also grouped first by HTTP Result Code and then by the Return Code from the script 34. This can be achieved by defining a dimension with two levels. The administrator drags HTTPResultCode to the right and chooses “Make Dimension”, which transforms it to a dimension sub-tree similar to the URL. The administrator then drags the ReturnCode from the ScriptExecution_End event onto the root of this dimension. Thus, Return Code becomes another level in the same dimension. Finally, the administrator renames the dimension to be called “Error”.

To obtain the report of FIG. 4, the duration from the first to the last event is averaged. To capture this in the tool, the administrator drags the root of HTTPRequest_Begin again, but this time the administrator chooses “Start Duration”. A new node appears with, for example, the clock and measurement arrow icon, and the event moves as the Start node below this Duration node. The administrator then drags the root of HTTPRequest_End onto the Duration node and it appears as the End event for this duration. Finally the administrator clicks on the Duration node and chooses “Make Measure”. He or she then selects the aggregation function (Average) and a new Measure node appears as parent of the Duration. The administrator than renames this to what he or she wants to see in the reports. The administrator may define another Duration (e.g., between ScriptExecution_Begin and ScriptExecution_End) as a measure.

If now the administrator clicks on any of the items in the right pane of the user interface tool (e.g., ReturnCode), the corresponding item in the event metadata gets highlighted, so it is clear where this comes from. With this, the tool now contains sufficient information how to produce the reports of, for example, FIGS. 3 and 4.

It should be appreciated that the various aspects of the invention are not limited to the specific look of the UI and the specific gestures. Rather, the user interface provides a tool that allows the user to capture several pieces of information, such as which events are of interest, activity (correlation) semantics, desired dimensional structure, including durations, and mapping between the events and the dimensional structure. Moreover, the web server 34 and administrator use case described above is merely exemplary. Those skilled in the art will readily understand that a business user, for example, could define reports of interest with the same ease from schematized event sources, such as RFID. In general, aspects of the invention are applicable to any user and any event stream with known metadata.

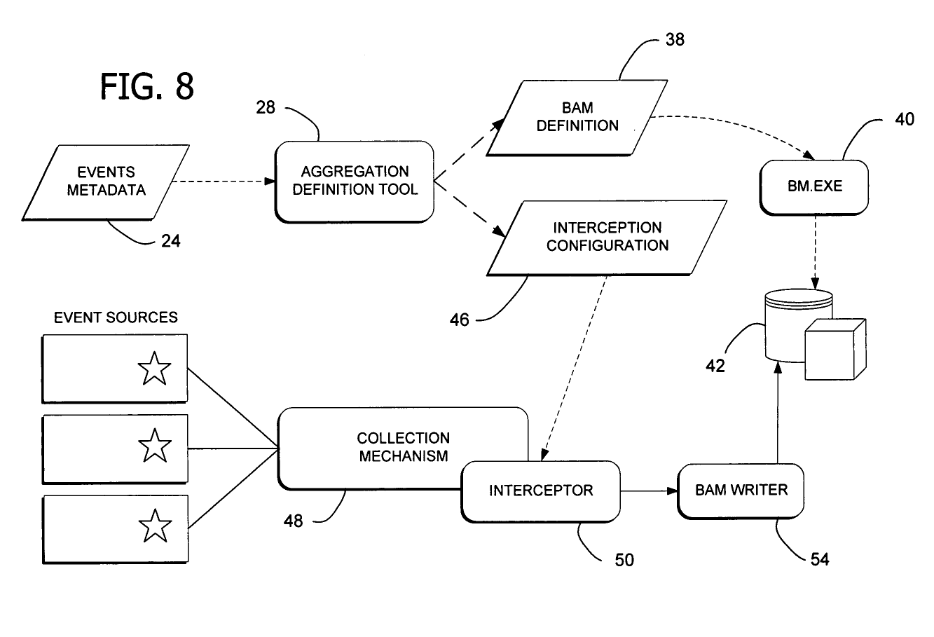

FIG. 8 is a block diagram of an exemplary computer system implementing further aspects of an embodiment of the invention. To illustrate how the information collected in this tool is sufficient for execution, one embodiment of the invention can be used to configure an existing BAM infrastructure. In this embodiment, metadata in the form of event stream 24 describes the schema of possible (i.e., available) events that may occur. The aggregation definition tool 28 consumes the metadata as described above. At its output, aggregation definition tool 28 produces a BAM definition 38 (e.g., an XML file). The BAM definition 38 may be in a standard format describing activities, measures and dimensions that are of interest. A command-line tool bm.exe 40 consumes the BAM definition 38 and produces a stream-aware data warehouse 42 (e.g., dynamic BAM infrastructure). Another output from the tool 28 is an interception configuration 46, which defines which defines the correlation hints and the mapping between the events and the activities in the BAM warehouse 42.

At runtime, an infrastructure or collection mechanism 48, such as the as MOM (operation monitoring events), Auditing Collection Service for Windows (security audit events) or RFID (business events), collects the events. A relatively small pluggable component (e.g., interceptor 50) filters and transforms the events from their original schema to Activity Change events, similar to the signature of a BAM API. Another component (or the same) takes the Activity Change events and calls the BAM API.

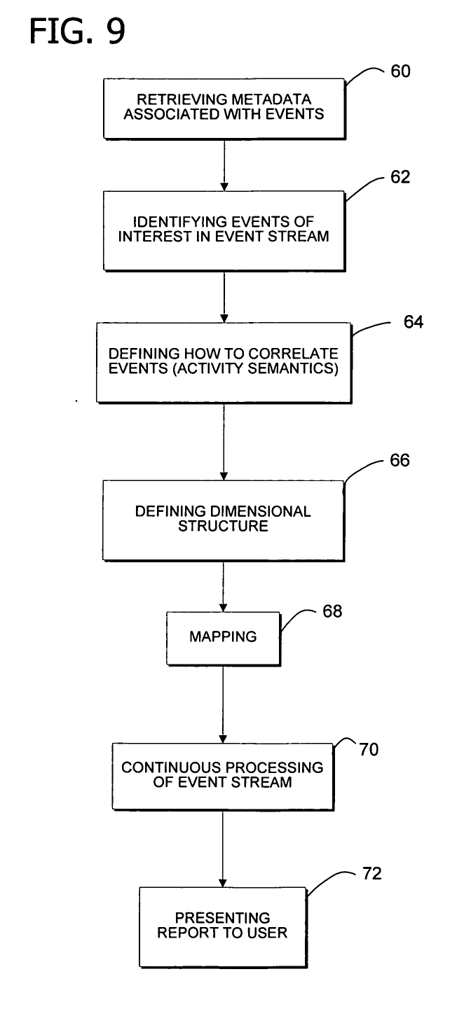

FIG. 9 is a flow diagram illustrating exemplary operations for generating reports from event stream 24 according to an embodiment of the invention. In operation, computer 22 executes computer-executable instructions for performing a method of generating a report from event stream 24, which includes a plurality of events. Beginning at 60, aggregation definition tool 28 receives event stream 24 and retrieves the metadata associated with the events of interest. Based on user input, one or more events of interest in event stream 24 are identified at 62. Proceeding to 64, aggregation definition tool 28 defines how to correlating these events of interest at 66 based on the metadata. Aspects of the invention permit defining a dimensional structure for the report at 66 and then mapping the correlated events to the dimensional structure at 68 for generating the report. At 70, continuous processing of the event stream occurs and, at 72, a user interface presents the information representative of the mapping to a user in the form of a report.

The exemplary operating environment illustrated in FIG. 1 includes a general purpose computing device (e.g., computing device 22) such as a computer executing computer-executable instructions. The computing device typically has at least some form of computer readable media. Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data.

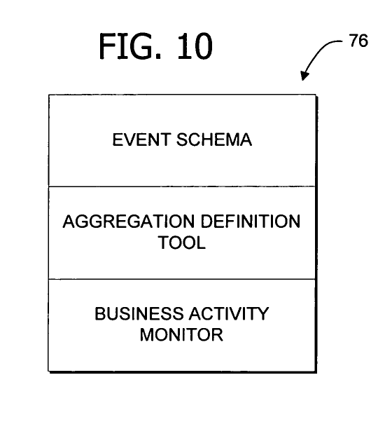

FIG. 10 is a block diagram illustrating an exemplary computer-readable medium 76 containing computer-executable instructions for implementing aspects of the invention. As shown, one embodiment of the invention includes an event schema component, an aggregation definition tool, and a business activity monitor.

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. A user may enter commands and information into the computing device through input devices or user interface selection devices such as a keyboard and a pointing device (e.g., a mouse, trackball, pen, or touch pad). Other input devices (not shown) may be connected to the computing device. A monitor or other type of display device (not shown) is also connected to the computing device. In addition to the monitor, computers often include other peripheral output devices (not shown) such as a printer and speakers, which may be connected through an output peripheral interface (not shown).

The computer 22 may operate in a networked environment using logical connections to one or more remote computers. The remote computer may be a personal computer, a server (e.g., servers 32), a router, a network PC, a peer device or other common network node, and typically includes many or all of the elements described above relative to computer 22. Such networking environments are commonplace in offices, enterprise-wide computer networks, intranets, and global computer networks (e.g., the Internet).

Although described in connection with an exemplary computing system environment, aspects of the invention are operational with numerous other general purpose or special purpose computing system environments or configurations. The computing system environment is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of embodiments of the invention, it is intended that all matter contained in the above description and shown in the accompanying drawings shall be interpreted as illustrative and not in a limiting sense.

What is claimed is:

1. A computerized method of generating a report from an event stream, said event stream comprising a plurality of events, said method comprising:
identifying one or more events of interest in the event stream;
retrieving metadata associated with the events of interest;
correlating the events of interest based on the metadata retrieved therefrom;
defining a dimensional structure for the report; and
mapping the correlated events to the dimensional structure to generate the report.

2. The method of claim 1, further comprising presenting, to a user, information representative of the mapping.

3. The method of claim 2, wherein presenting information representative of the mapping comprises generating a graphical report.

4. The method of claim 3, wherein said graphical report comprises at least one of the following: a bar chart, a pie chart, and a table.

5. The method of claim 1, wherein identifying the events of interest comprises receiving user input defining one or more activities, said activities each including a plurality of instances of at least one of the events in the event stream.

6. The method of claim 5, further comprising defining a starting event and an ending event for each of the defined activities.

7. The method of claim 1, wherein identifying the events of interest comprises displaying, to a user, an event schema, said event schema displaying the events in the event stream and the metadata associated therewith.

8. The method of claim 1, wherein one or more computer-readable media have computer-executable instructions for performing the method recited in claim 1.

9. In a computer system having a display, said display having a user interface rendered thereon, said user interface comprising:
an event component for displaying a plurality of available events in an event stream;
a metadata component for displaying metadata associated with the available events;
a selection component responsive to user input for selecting one or more events of interest from the event component based on the displayed metadata associated therewith; and
a structure component responsive to user input for defining a correlation key and dimensional structure for organizing the selected events of interest.

10. The user interface of claim 9, further comprising a report component for displaying the dimensional structure having the selected events of interest mapped to the dimensional structure according to the correlation key.

11. The user interface of claim 10, wherein the report component comprises a graphical report.

12. The user interface of claim 11, wherein said graphical report comprises at least one of the following: a bar chart, a pie chart, and a table.

13. The user interface of claim 9, wherein the correlation key specifies one or more activities, said activities each including a plurality of instances of at least one of the events of interest.

14. The user interface of claim 13, wherein the selection component is responsive to user input for defining a starting event and an ending event for each of the specified activities.

15. The user interface of claim 9, wherein the structure component is responsive to user input for defining one or more of the events of interest as a dimension.

16. The user interface of claim 9, wherein the structure component is responsive to user input for defining one or more of the events of interest as a measure.

17. At least one computer-readable medium having computer-executable instructions for generating a report from an event stream, said computer-readable medium comprising:
an event schema describing available events in the event stream and metadata associated therewith;
an aggregation definition tool receiving and responsive to user input for identifying one or more events of interest in the event stream and correlating the events of interest based on the metadata described in the event schema; and
a business activity monitor for producing one or more activity definitions according to the correlated events of interest and for producing a data warehouse of the activity definitions.

18. The computer-readable medium of claim 17, further comprising an interception configuration for defining a mapping between the correlated events of interest and the activity definitions in the data warehouse.

19. The computer-readable medium of claim 18, further comprising a view component responsive to user input for generating a graphical user interface displaying selected activity definitions from the data warehouse.

20. The computer-readable medium of claim 17, wherein the aggregation definition tool is responsive to user input for specifying a dimensional structure of the correlated events of interest.
